(19) United States
(12) Patent Application Publication
(10) Pub. No.: US 2011/0172930 A1
(43) Pub. Date: Jul. 14, 2011

(54) DISCOVERY OF t-HOMOLOGY IN A SET OF SEQUENCES AND PRODUCTION OF LISTS OF t-HOMOLOGOUS SEQUENCES WITH PREDEFINED PROPERTIES

(75) Inventors: Petr Pancoska, Pittsburgh, PA (US); Robert A. Branch, Pittsburgh, PA (US); Patrick M. Dudas, Edinburg, PA (US)

(73) Assignee: University of Pittsburgh - Of the Commonwealth System of Higher Education, Pittsburgh, PA (US)

(21) Appl. No.: 13/063,832

(22) PCT Filed: Sep. 18, 2009
(86) PCT No.: PCT/US09/57438

§ 371 Date: Mar. 14, 2011

Related U.S. Application Data
(60) Provisional application No. 61/098,599, filed on Sep. 19, 2008.

(51) Int. Cl. G06F 19/00

(52) U.S. Cl. 702/20

(57) ABSTRACT

System(s) and method(s) for analysis and design of genome sequences are provided. A graph representation of a genome sequence facilitates generation of a thermodynamic based quantity, e.g., an entropy-based and enthalpy-based thermodynamic tolerance [τ], which in turn affords estimation of a gene sequence potential function that depends at least upon structural and functional properties of the gene sequence. The gene sequence potential (Φ) is determined, at least in part, via a generalized Schrödinger equation for the thermodynamic tolerance. Gene sequence potential and thermodynamic tolerance [τ], and derived quantities, like thermodynamic tolerance profile and generalized homology, provide an analytic instrument for characterization of natural and synthetic gene sequences, and in conjunction with graph-based algorithms embodies a tool for design of genome sequences with predetermined properties.

### CROSS-REFERENCE TO RELATED APPLICATIONS

This application claims the benefit of U.S. Provisional Patent application Ser. No. 61/098,599 entitled “METHOD AND APPARATUS FOR DISCOVERING τ-HOMOLOGY IN A SET OF SEQUENCES AND PRODUCING LISTS OF τ-HOMOLOGOUS SEQUENCES WITH PREDEFINED PROPERTIES,” filed Sep. 19, 2008. The entirety of the above-noted application is incorporated by reference herein.

### NOTICE ON GOVERNMENT FUNDING

This invention was made with government support under grants NIH/NIAID R01 AI067780, NIH 1 P50 HL084948-01, NIH 1 U10 HD47905-03, and NIH 1U54RR023506-01 awarded by the National Institutes of Health.

### TECHNICAL FIELD

The subject innovation relates generally to quantitative biology, and more particularly to characterization, analysis and design of genome sequences through a biological gene potential Φ and associated thermodynamic tolerance τ or equivalently, the optimization energy of incorporation of segment into the genome and its homology

### BACKGROUND

Preparation and characterization of genomic sequences for gene mapping and disease origin and propensity (e.g., identification of genes for hereditary breast cancer); drug development and gene therapy; and fundamental understanding of genome functionality (e.g, folding loci) typically involves substantive experimentation with genome-sequence samples and data mining of available databases of experimentally derived information, experimental data collections and other resources. In addition, conventional analysis techniques generally incorporate local (e.g., single-base or few base or codon related) effects into analysis of gene sequences even though functionality of a gene sequence is typically determined within a scale determined by more than a few codons.

Even though conventional method(s) rely upon a sequence alignment to generate families of sequences related to a specific sequence that is analyzed, these conventional methods fail to conduct an exhaustive exploration of properties associated with the analyzed sequence. Thus, commonplace or traditional analysis lacks sufficient diversity to capture a myriad of factors that can affect folding, functionality, stability, response to mutation, interaction with other sequences, individual molecules, or aggregates or complexes of molecules, such as regulatory factors and so forth. Furthermore, design of biopolymeric sequences with specific properties is substantially limited as a consequence of the prohibitive complexity of exhaustive analysis and evaluation of blindly designed molecules.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises system(s) and method(s) for analysis and design of genome sequences and products of their transcription. Analysis relies at least in part on a graph representation of the analyzed sequence that facilitates generation of a thermodynamic quantity, e.g., an entropy-based and enthalpy-based thermodynamic tolerance, which in turn affords estimation of a gene sequence potential function (Φ). The gene sequence potential can be determined at least via a scale-modified Schrödinger equation. Functional aspects of the gene sequence are contained in Φ, such as folding pathways, attachment points of proteins or small molecules, and the like.

Thermodynamic tolerance and derived quantities, like a thermodynamic tolerance profile and generalized homology, provide an analytic instrument for characterization of natural and synthetic gene sequences.

Moreover, the subject innovation facilitates design of gene sequences utilizing predetermined or target properties. Such an “inverse problem” solution, namely identification of a gene sequence with one or more desired properties, is afforded herein via generation computation of gene potentials for candidate sequences and successive screening of resulting Φs for those with the one or more desired properties. It should be appreciated that various “inverse problem” or design strategies can be incorporated in the subject innovation such as a genetic algorithm, or substantially any other algorithm for material design (e.g., cluster expansion, combinatorial design), wherein a specific feature of a generated gene sequence potential can be employed as a metric or fitness score to drive a design and achieve specific gene sequence properties, and/or characterization of graphs of prototype sequences with a desired property and subsequent derivation of one or more new sequences from these graphs.

In addition, the subject innovation can enable determination of functional significance of sequences by collectively extracting their evolutionary history, physical properties, boundaries and series of distances (τ-homology) to similar sequences within a set of sequences. The innovation discloses methods of generating composition of matter present neither in original nor in other sequences in terms of providing a way of determining additional sequences that share τ-homology with those determined by above methods. Determination of τ-homology proceeds through an unsupervised analysis of single sequence (e.g., chromosome) or alternatively with analysis of series of sequences. The innovation analysis can be unsupervised in that it proceeds with the τ-homology analysis without information related to example sequences that define a family of sequences, without aligning the sequences, without prior knowledge of patterns in the example sequences, and without knowledge of the cardinality or characteristics of features that may be present in the example sequences.

In yet another aspect of the innovation, a method is used to take a single sequence or a set of unaligned sequences and discover several or many patterns that share τ-homology to some or all of the sequences. These patterns can then be used to determine if candidate sequences are members of the family. In another aspect of the innovation, a method is used to take a set of sequences and to determine a set of maximal patterns common to a number of sequences. In another aspect, the unique sequences are used to generate composition of matter of all other sequences that exhibit τ-homology with analyzed sequences.

In still another aspect, the innovation as described herein can be utilized to restrict generation of novel sequences with predefined properties or functionality. It should be appreciated that the innovation can be utilized to analyze and design substantially any finite polymer sequence or finite solid state material that presents a linear structure. It is to be further noted that polymer sequences that display a non-linear atomic structure, but afford a graph representation with a finite number of closed paths, can be partially analyzed in accordance with aspects of the subject innovation.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example evaluation system which facilitates translational quantum genetics in accordance with one aspect of the innovation.

FIG. 2 illustrates an example flow chart of procedures that facilitate sequence analysis in accordance with an aspect of the innovation.

FIG. 3 (Example 10) illustrates an example block diagram of procedures which facilitate a gene sequence generation according to a set of gene sequence design requirements.

FIG. 4A illustrates a second example evaluation system for facilitating translational quantum genetics in accordance with a second aspect of the innovation.

FIG. 4B illustrates an example polymerization reaction where a next segment k is generated from a precursor deoxyribonucleic acid (DNA) sequence.

FIG. 4C illustrates an example DNA graph Γ and an example corresponding adjacency matrix AΓ.

FIG. 4D illustrates a second example DNA graph Γ2.

FIG. 4E illustrates difference in the incorporation energies between two types of DNA segments from differing pools of iso-energetic alternatives.

FIG. 4F illustrates an example distribution of ττ intensities in comparison to Planck law intensities.

FIG. 4G illustrates an example model of multiple segments which depicts emergence of long range coherence of physiochemical properties along an example genome sequence.

FIG. 4H illustrates an example of evolutionary optimization and relevance of synonymous mutations determinable from biological gene potential Φ and its associated thermodynamic tolerance τ and its homology.

FIG. 4I illustrates an example of the relationship of entromic entropy to a rate of single point mutation in a genome

FIG. 5A illustrates an example a third example DNA graph Γ3.

FIG. 5B illustrates an example thermodynamically homogeneous pool of a unique size.

FIG. 5C illustrates an example coding for synonymous protein segments.

FIG. 5D illustrates a plot of 1/Mᵢ as a function of position.

FIG. 5E illustrates an example biliverdin reductase from which FIG. 5D is derived.

FIG. 6 illustrates an example potential for mutation for a variant of influenza H1N1.

FIG. 7 illustrates example entromic characterizations of regions of virus genomes.

FIG. 8 illustrates an example comparison of coherences for a human and a mouse polymerase beta.

FIG. 9 illustrates an example application of entromic entropy for identification of binding sites of drug complexes

FIG. 10 illustrates an example of synonymous mutations of codons within an exon 12 of a cystic fibrosis conductance regulator (CFTR) which influences inclusion or exclusion of this exon in a transcribed protein.

FIG. 11 illustrates a set of optimal properties of a “barcode” region for a micro-array based detection device.

FIG. 12 illustrates a block diagram of a computer operable to execute the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

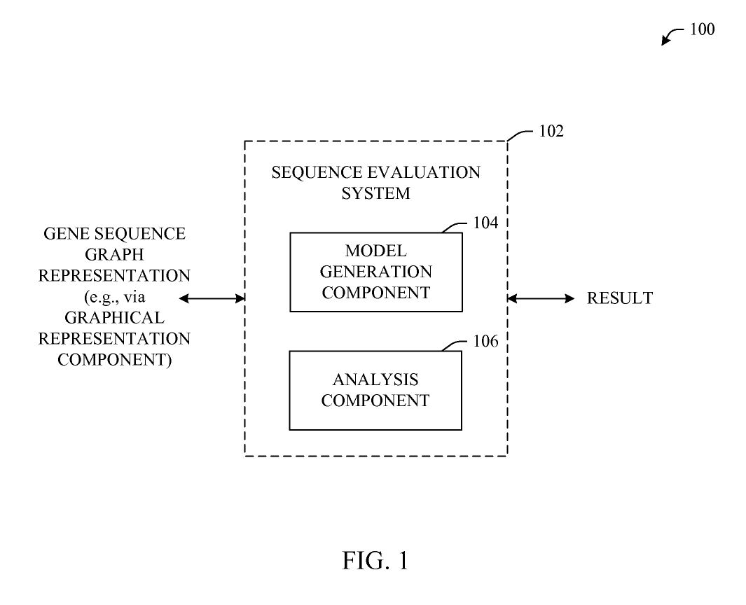

With reference now to the drawings, FIG. 1 illustrates a system 100 that facilitates translational quantum genetics in accordance with aspects of the innovation. Generally, system 100 can include a sequence evaluation system 102 that employs a model generation component 104 and an analysis component 106 that can evaluate a graphical representation of a sequence, such as a gene sequence. Briefly described, the evaluation system 102 relates generally to modeling (104) and analysis (106) of polymer sequences and, more particularly, gene sequences or genomes. As illustrated, the evaluation relies at least in part on a graphical representation of the subject sequence(s) that facilitates generation of a thermodynamic quantity, e.g., an entropy-based and enthalpy-based thermodynamic tolerance, which in turn affords estimation of a gene sequence potential function.

By way of the model generation component 104, the gene sequence potential (Φ) is determined at least via a quantum-mechanics type Schrödinger equation or equivalent system of mathematical equations. Functional aspects of the gene sequence can be contained in Φ. Thermodynamic tolerance and derived quantities, like thermodynamic tolerance profile and generalized homology, provide an analytic instrument for characterization of natural and synthetic gene sequences. It will be understood and appreciated that these values and factors can be established via the model generation component 104 in conjunction with the analysis component 106. Functionality of the sequence evaluation system 102 is based at least in part on a combination of graph theory and statistical thermodynamics. The mechanics of sequence evaluation will be described in greater detail below.

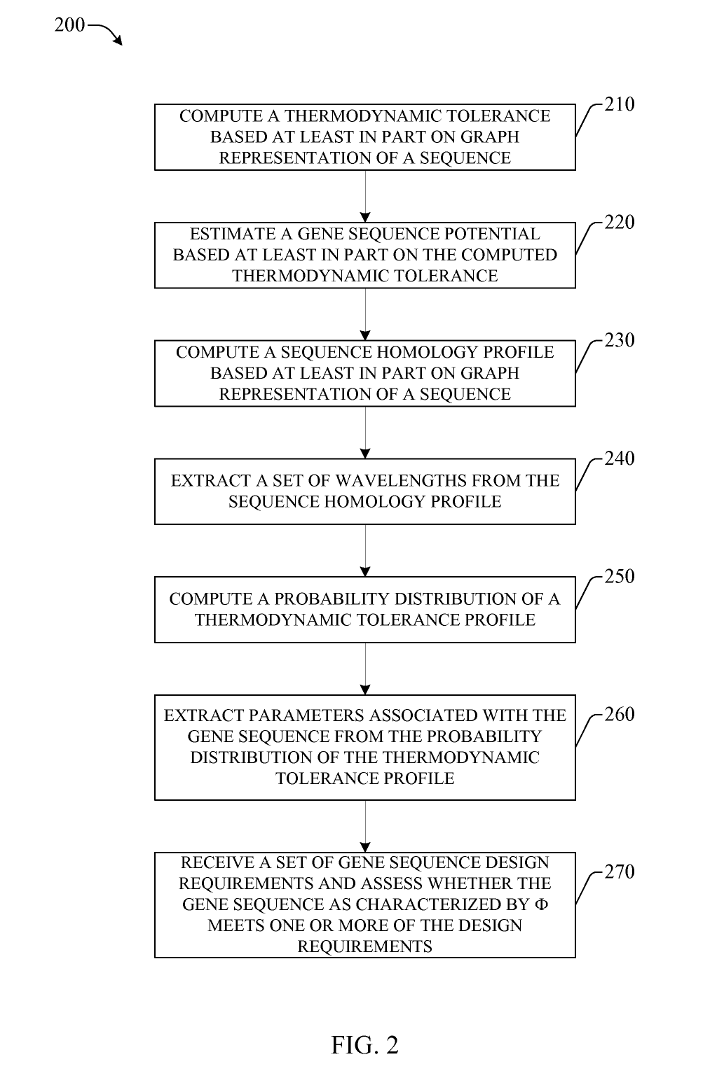

In view of the example system 100 shown and described above, a methodology that may be implemented in accordance with the disclosed subject matter will be better appreciated with reference to the flow chart of FIG. 2. While, for purposes of simplicity of explanation, the methodology is shown and described as a series of blocks, it is to be understood and appreciated that the claimed subject matter is not limited by the number or order of blocks, as some blocks may occur in different orders and/or concurrently with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. It is to be understood and appreciated that that a methodology could alternatively be represented as a series of interrelated states or events, such as in a state diagram or interaction flow.

FIG. 2 presents a flowchart of an example method 200 for analyzing and designing gene sequences. At act 210, a thermodynamic tolerance [τ] is computed based at least in part on a graphical representation of the sequence to be analyzed. As discussed herein, the computation includes selecting multiple discretization intervals, and padding the analyzed gene sequence with a buffer sequence, e.g., between the 5′ and 3′ ends prior to applying periodic boundary conditions. Buffer layer and periodic boundary conditions mitigate finite-length or “shortening” problems. Through computation of the number of closed paths in every discretized interval, the multidimensional representation of thermodynamic tolerance may be obtained.

At act 220, a gene sequence potential (Φ) is estimated based at least in part on the computed thermodynamic tolerance. Such estimation can be based on a scale-generalized Schrödinger equation (e.g., equation (1) below) or equivalent system of other mathematical equations according to aspects described herein. Generation of the gene sequence potential provides information on structural and functional aspects of the various segments that comprise the analyzed gene sequence.

At act 230, a sequence homology profile, e.g., τ-homology profile, is computed based at least in part on the graph representation of the gene sequence. Various metrics that exploit matrix elements of various adjacency matrices associated with segments of the gene sequence facilitate generation of the sequence profile. At act 240, a set of wavefunctions and their parameters is extracted to form the sequence homology profile. Such wavefunctions and their parameters characterize coherent, long-range aspects of structural and functional aspects of the gene sequence.

At act 250, a probability distribution of a thermodynamic tolerance profile is computed. At act 260, parameters associated with the gene sequence are extracted from the probability distribution computed in act 270. The extracted parameters in combination with thermodynamic tolerance derived from multiplicities of Eulerian paths extant in the graph representation of the gene sequence afford relative comparisons of functionality of the segments that discretize the gene sequence. It should be appreciated that each Eulerian path in a graph representation of an originating gene sequence (e.g., a “mother” sequence) generates multiple non-identical gene sequences (e.g., “daughter” sequences) that are thermodynamically isostable with the originating gene sequence or genome sequence and can replace the original “mother” sequence in genome without alteration of the necessary incorporation energy.

At act 270, a set of gene sequence design requirements is received and it is assessed whether the gene sequence as characterized by Φ meets one or more of the design requirements. It is to be noted that substantially all information generated through enacting example method 200 for gene sequence analysis and design can be retained in a memory element (e.g., a volatile or non-volatile memory component such as for example a random access memory) for further analysis (e.g., data mining), documentation, commercialization or the like. Furthermore, example method 200 for gene sequence analysis and design can be stored or packaged in an article of manufacture (e.g., a computer-readable medium with instructions stored thereon) for utilization of the method; e.g., transportation, execution, commercialization, etc.

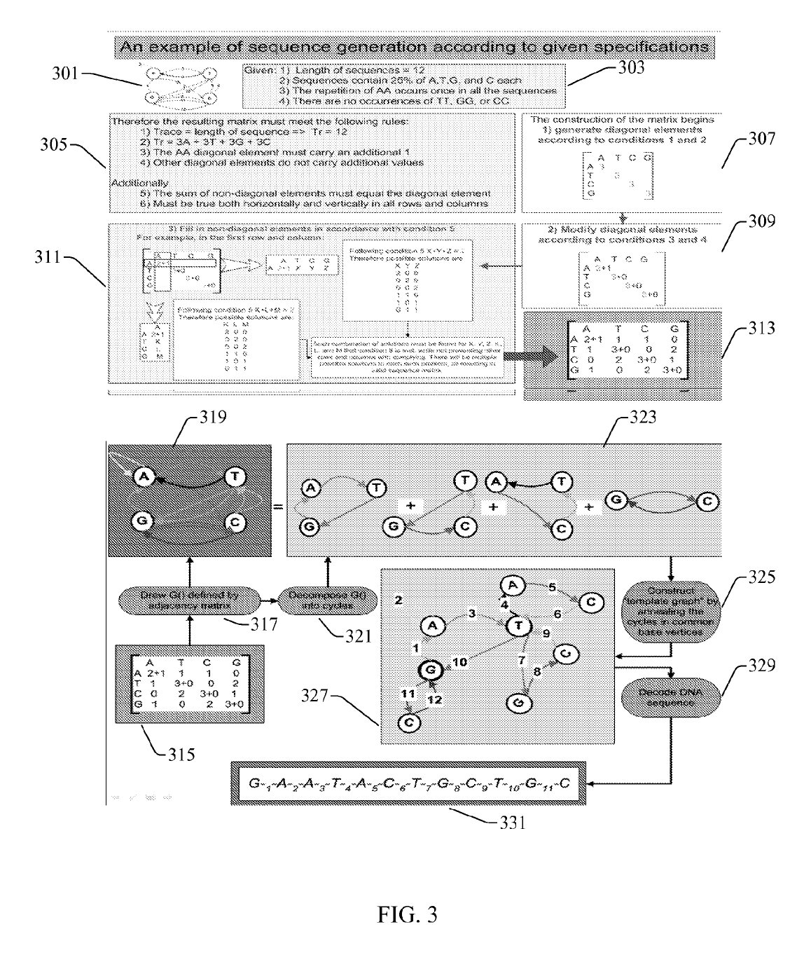

FIG. 3 illustrates one example where a gene sequence is generated according to a set of given gene sequence design requirements. Component 303 includes a list of the given gene sequence design requirements. For example, the list includes a length for the sequences equal to twelve (12). The list further includes the sequences contain 25% of A, T, G and C each. Component 305 depicts the requirements that entromics puts on elements of resulting matrix, according to the given design requirements. Component 301 illustrates a graph representation of given example of de novo constructed gene sequence. Components 307, 309 and 311 illustrate the construction of an example matrix according to the design requirements.

Component 313 of FIG. 3 illustrates an example matrix from which multiple gene sequences may be decoded. Components 315-331 illustrate the acts of decoding based on the example matrix 313. Component 315 illustrates again the given example adjacency matrix which DNA grapher 317 uses to populate an example DNA graph 319. A gene sequence decomposer 321 generates cycles 323 from the given graph 319. A template constructor 325 iteratively anneals the gene cycles 323 in all combinations of common base vertices 327. At each iteration, a DNA sequencer 329 decodes a DNA sequence 331 based on the common base vertices 327. Additional sequences may be generated by systematic repeating of the algorithm steps so that all Eulerian paths in a given DNA graph are used. In another aspect of this innovation, the algorithm may stop once a user-requested number of sequences are generated.

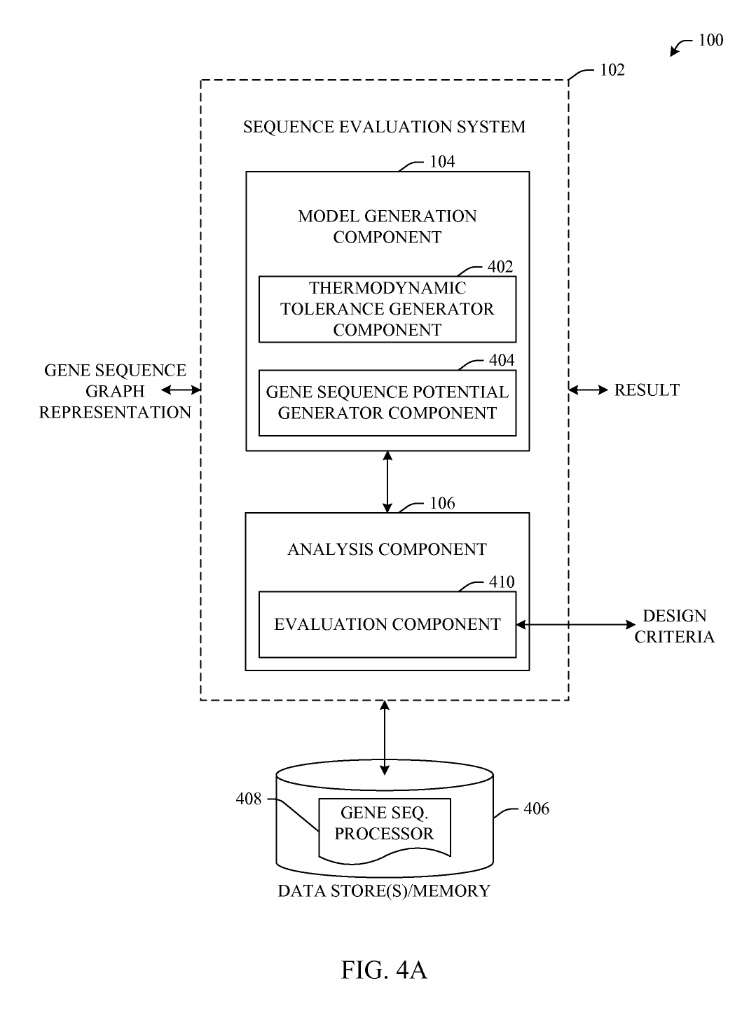

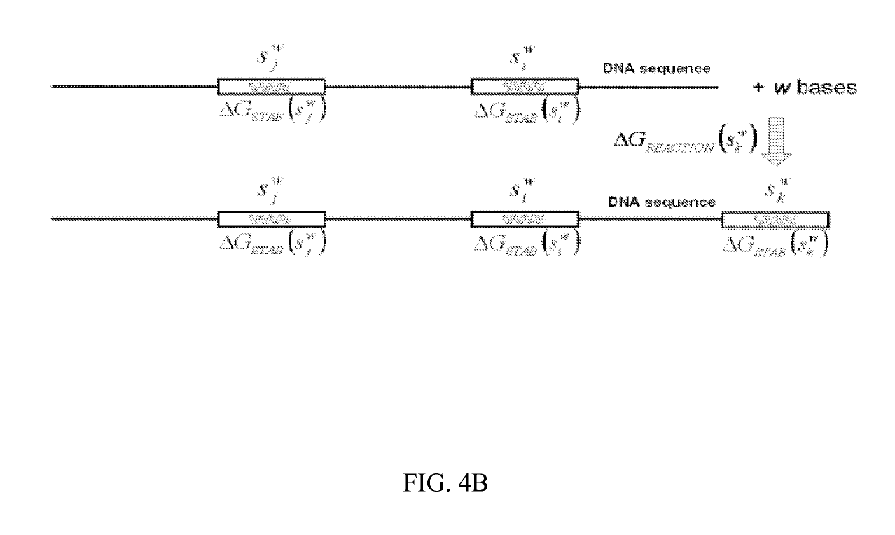

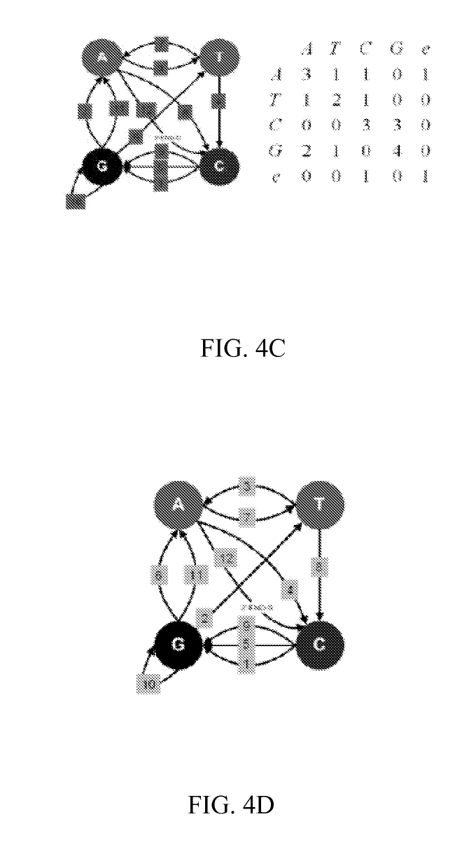

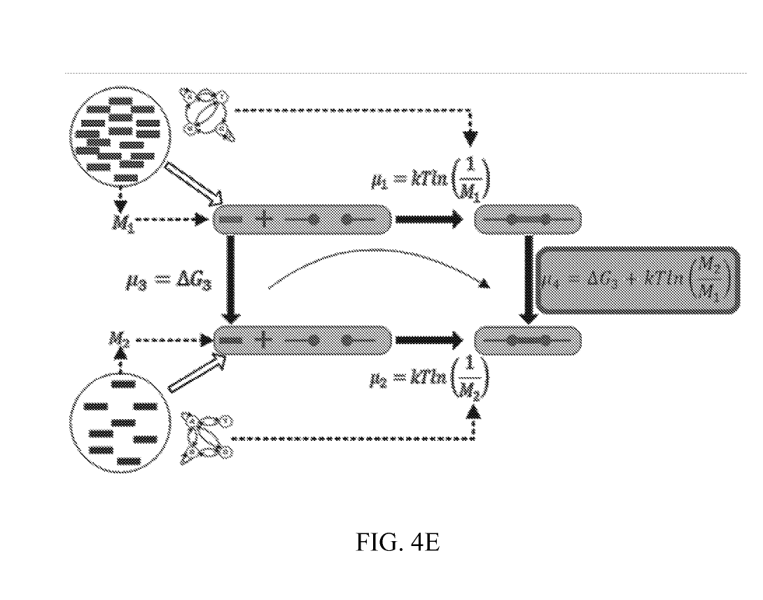

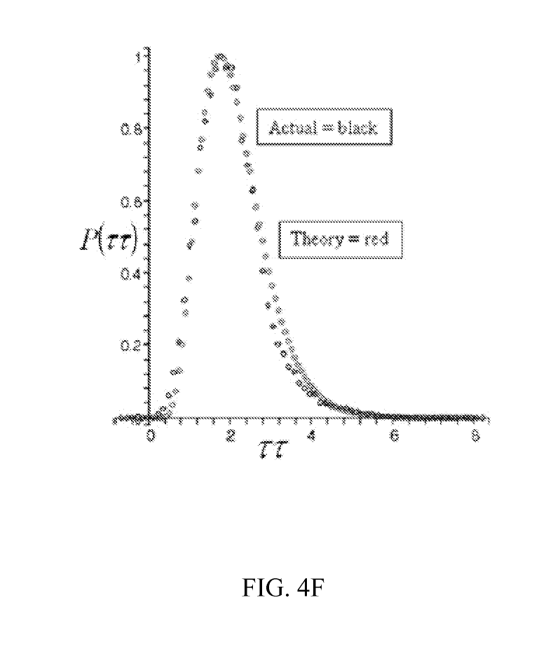

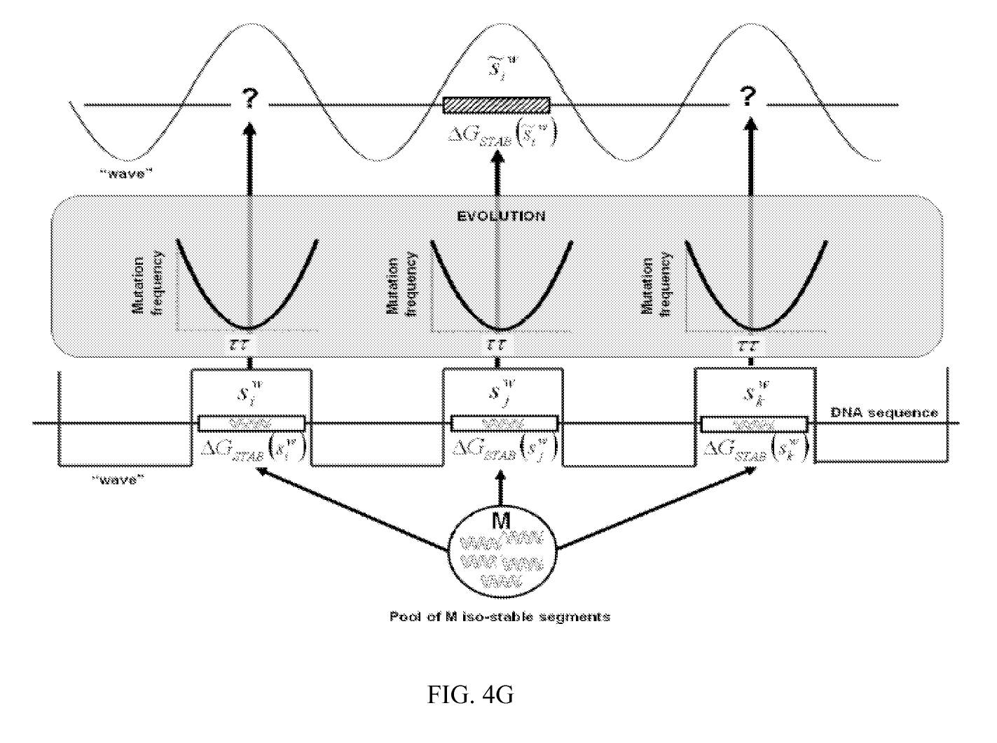

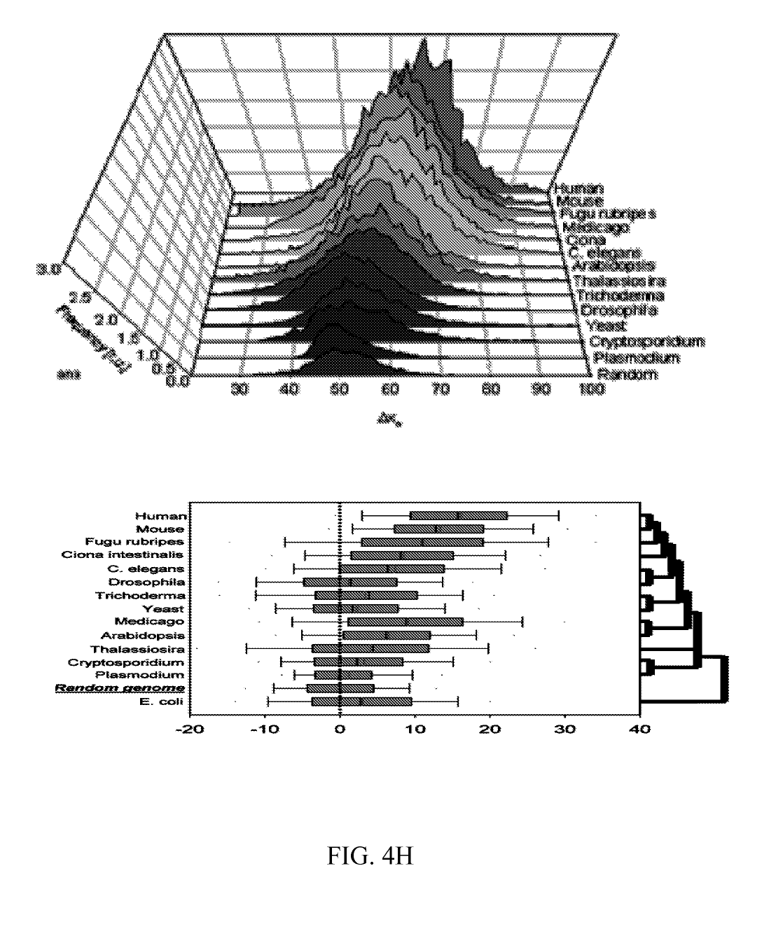

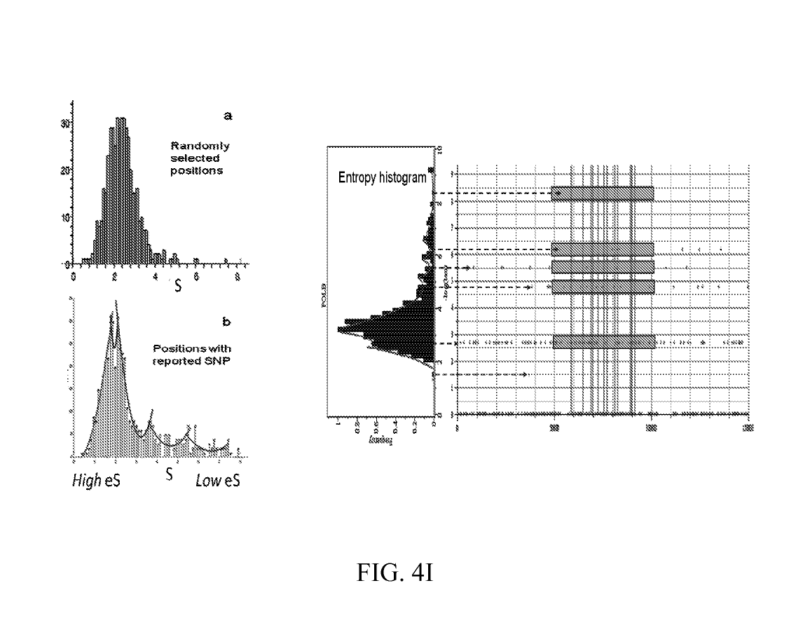

Referring now FIG. 4A, illustrated therein is an alternative example of system 100 for analysis or design of a gene sequence in accordance with aspects described herein. A thermodynamic tolerance generator component 402 receives a set of gene sequences and generates, e.g., computes, a thermodynamic tolerance matrix [τ] as described above. A gene sequence potential generator component 404 receives a thermodynamic tolerance matrix and evaluates a gene sequence potential (Φ) in accordance with Equation (1) described below. The computed Φ can be retained within a memory, or memory component, 406 as a part of gene sequence processor 408. In addition, gene sequence processor 408 can include artificial-intelligence patterns, or other information, extracted from an analysis component 106 that can generate structural and functional information from a computed thermodynamic tolerance matrix or from a generated Φ. In example system 100, an evaluation component 410 can evaluate generated gene sequence informative patterns 408 and determine whether a gene sequence meets one or more design criteria. It should be appreciated that a gene sequence can carry substantial commercial value.

A processor (not shown in FIG. 4A) can confer at least in part the functionality of substantially all components in example system 100. To such end, the processor can execute code instructions stored in memory (instructions not shown in FIG. 1), or in substantially any memory functionally coupled to the processor. Alternatively, or in addition, one or more components of example system 100 can reside at least in part within memory, and the processor can execute such components to exploit their functionality. The processor can be substantially any computing device such as for example a single-core processor, a multi-core processor, an application-specific integrated circuit, and so forth.

Following are aspects that are included to add perspective or context to the innovation. For this reason, it is to be understood that these examples are not intended to limit the innovation in any manner. As such, other examples exist and will be appreciated that may be included within the spirit and scope of this innovation and claims appended hereto.

To further describe the following example aspects, FIG. 4B illustrates a polymerization reaction where a segment k is generated from a precursor DNA sequence. From this polymerization reaction a number of details and principles may be drawn and derived. In addition, reference to elements within FIG. 4B are made in later figures.

The energy cost of incorporating a segment k into the sequence is defined by a Gibbs free energy value ΔG_{REACTION}(sᵢ^{(w)}). This value also characterizes a segment's position within the genome. The ΔG_{REACTION}(sᵢ^{(w)}) contribution is calculated via a combination of mathematical theorems of graph theory and statistical thermodynamic principles. This value may be determined only because any DNA sequence may be encoded in the form of an oriented graph Γ.

In an example aspect of the innovation a DNA (deoxyribonucleic acid) sequence may be represented as a graph Γ, illustrated in FIG. 4C on the left-hand side, comprising four vertices associated with bases A, T, C, and G; or A,U,C,G in RNA (ribonucleic acid) molecules or in nucleic acids with synthetic or natural analogs of these bases—in general, with substantially any finite set of monomers—in view of the linearity of DNA, RNA and other biopolymer molecules, Γ is an Eulerian graph.

As described supra, for such an Eulerian graph, multiple paths, Eulerian paths or cycles within this graph can represent multiple realizations of disparate DNA sequences associated with the sequence from which Γ originates (see e.g., FIG. 4D). The multiple Eulerian paths can be algorithmically generated, the number of paths M can be computed in closed form once the Γ is known. It should be appreciated that that the multiple realizations of DNA sequences share an adjacency matrix A|Γ| for graph Γ shown on the right-hand side of FIG. 4C, in view that the Eulerian paths belong to the same graph. It should further be appreciated that DNA sequences that share the same adjacency matrix are substantially thermodynamically isostable.

In thermodynamic terms, sharing the adjacency matrix A|Γ| means that any pair of DNA molecules share a length and have an identical number and an identical type of nearest neighbor stacking interactions. Sequences which share an adjacency matrix may also share longer-range sequence context features, for example, various non-identical paths which are thermodynamically iso-stable.

FIG. 4E illustrates a further example of entromics fundamental tools that provide the thermodynamic tolerance characterization of genome. Here Mᵢ is a number of DNA segments in pools of iso-energetic alternatives, which may be calculated from the graph-representation Γ of natural DNA. The equation on the right quantifies the resulting difference in the incorporation energies between two types of DNA segments that characterize two components of thermodynamic tolerance.

Therefore, in accordance with the subject innovation, a single DNA sequence can facilitate generation of a set of disparate DNA sequences that are substantially theimodynamically isostable without computation of thermodynamic Gibbs free energy of stability (ΔG_{STAB}) for the set of disparate sequences and at the same time they all share the identical energy of incorporation into the genome. Accordingly, the generation of sequences does not rely on any one specific thermodynamic model, either ab initio or empirical, e.g, that utilizes experimental data for thermodynamic quantities. In this way, each sequence position i may be associated with the thermodynamic stability (ΔG_{STAB}) as well as with the energy cost ΔG_{REACTION}(sᵢ^{(w)}). As such, M, is directly related to entropy part of the total incorporation energy.

The foregoing facilitates the modeling properties of a gene sequence (e.g., via model generation component 104). Upon discretization of the gene sequence in a set {sᵢ^{(w)}} of elementary segments of systematically variable length w, e.g., a contextual scale, a thermodynamic tolerance τᵢ=−kT log(Mᵢ) can be introduced (e.g., via thermodynamic tolerance generator component 402). The thermodynamic tolerance is related to the chemical potential μᵢ, or energy of incorporation, of a segment sᵢ^{(w)} into the gene sequence. It should be appreciated that the thermodynamic tolerance depends parametrically on length w, and thus τᵢ can provide an instrument of characterization of a gene position through generation of a series of values {τᵢ^{(w)}} for a series of lengths w. Thus, for a gene sequence of length N, a thermodynamic tolerance matrix [τ] of dimension N×n_{w} can be generated, wherein n_{w} is the number of discretization intervals. The N columns representing τᵢ^{w)} are a functional transformation, for example, of all the DNA segments sᵢ^{(w)} into values of Mᵢ followed by individual normalization. The values within the τ matrix may be averaged to generate a thermodynamic tolerance profile TTᵢ. These values may be made more manageable by applying a logarithmic transformation to define a thermodynamic tolerance profile ττᵢ=−kT. log(TTᵢ).

A thermodynamic tolerance matrix [τ] and profile ττᵢ may be used to help identify undetected networks of gene segments that are both homologous and non-homologous but with a coherence of [τ]. This coherence may, for example, correlate with encoding of functionality and/or structural correlation but non-contiguousness of parts of a genome sequence. The thermodynamic tolerance profile ττᵢ is also an indicator of thermodynamic stability (ΔG_{STAB}), and as such, a frequency distribution of ττᵢ as illustrated in FIG. 4F corresponds to a Planck's distribution as described by the following equation:

$$P [ ττ ] = \frac{A {ττ}^{a}}{{e}^{\frac{ττ}{\tilde{k} \tilde{T}} ( Q - 1 )} - 1}$$

where A is a normalization constant, α=2 is dimensionality of the genome in [τ] representation, k acts as an effective Boltzman constant and T is an effective biological temperature. Q represents a mean number of segments from one pool present simultaneously in the same DNA sequence. As seen from FIG. 4F and the above equation, the presence of multiple segments (Q>1) sᵢ^{(w)} exists in one pool in a genome. As such, the distribution of multiple segments with identical thermodynamic properties along a genome sequence constitutes coherence information that is functional and also “readable” by a biological system.

Additionally, graph representation of a segment sᵢ^{(w)} centered in a position rᵢ and a segment sⱼ^{(w)} centered around position rⱼ within the gene sequence can be utilized to define a generalized homology, or τ-homology, for the pair of positions rᵢ and rⱼ. In one aspect, a τ-homology profile arises from a metric defined through matrix elements of the adjacency matrices A|Γ(sᵢ^{(w)})| and

$$A \vert Γ ( {s}_{j}^{( w )} ) \vert \text{:} {δ}_{i} = \frac{1}{N - 1} {\sum }_{k = 1}^{N - 1} {δ}_{ik} ,$$

where

$${δ}_{nm} = {\sum }_{p = 1}^{4} {\sum }_{q = 1}^{4} \sqrt{{( {a}_{pq}^{( n )} - {a}_{pq}^{( m )} )}^{2}}$$

and αₛᵥ^{(t)} are matrix elements of the adjacency matrix. It is to be noted that alternative, or additional, definitions of formulae that allow quantitative characterization allow that the τ-homology can be designed using adjacency matrices and their elements or properties, such as eigenvectors or eigenvalues and other descriptors or invariants. Unique signatures of all segments sᵢ^{(w)} from one pool associated with a same DNA graph Γ sᵢ^{(w)} share the same adjacency matrix A|Γ|sᵢ^{(w)}. As such, a direct algorithm may search for evolution-perturbed but sufficiently conserved multiplets of s^{(w)}, as described herein with reference to FIG. 4

Maxima of comparable intensity/height in a τ-homology profile reveal loci that are maximally property coherent in disparate loci in the sequence. Typical τ-homology profiles can present short range fluctuations modulated by an envelope whose periodicity, or wavefunction, and localization properties correlate with structural and functional properties of an analyzed gene sequence. Therefore, τ-homology is an analytical tool that can unveil functionally and structurally correlated but non-contiguous portions of a gene sequence. Correlation(s) revealed by a τ-homology can be associated with networks of property homologous but sequence non-identical or dissimilar gene segments in addition to the limited networks of segments exhibiting sequence similarity, which are thus only a special case of τ-homology. It is noted that conventional sequence similarity and homology analysis typically fails to incorporate non-homologous or non-similar segments in a sequence analysis. In addition, it is to be recognized that τ-homology analysis of the subject innovation can be conducted at the single sequence level.

It should be appreciated that sequence design, in accordance with the innovation, can be pursued as an “inverse problem” wherein sequences can be screened for a specific τ-homology (e.g., via evaluation component 410). Various algorithms may be implemented for solution of the inverse problem, such as a genetic algorithm wherein a set of N sequences (N is a positive integer) each associated through a shared graph with a position-dependent segment that discretizes a gene sequence are combined into an N-configuration arrangement of sequences to produce a new form of matter, one or more properties of the new form of matter optimized in accordance with the genetic algorithm. It should be appreciated that τ-homology can be quantified in terms of differences or distances of graph invariants and employed as a fitness score to optimize a predetermined property of an arrangement of N-segments.

Additionally, τ-homology provides a long-range analysis or recognition scheme within a genome sequence, wherein correlated physicochemical properties of a sequence are revealed as “coherence waves” (e.g., the envelope of short-range fluctuations or representation of dominant Fourier or wavelet components). A wavefunction in a τ-homology coherence wave can label a characteristic aspect of a gene segment (e.g., folding properties, binding locus or site location), such wavefunction can reflect a confinement within natural boundaries in the gene segment associated with the characteristic aspect. Additionally, each coherence wave and its wavefunction can be associated with a well-defined state of the thermodynamic tolerance. In an aspect of the subject innovation, such confinement is characterized through a gene sequence potential Φ function, established by the gene sequence potential generator component 404. A relationship among Φ and the thermodynamic tolerance matrix [τ] is discussed below.

To generate a relationship among Φ and [τ], it is observed that (i) the thermodynamic tolerance is a function of position p in a gene sequence and contextual scale w, and (ii) confinement potential determines “diffusion” of long-range correlations of [τ]. Accordingly, from (i) and (ii), a scale-generalized, quantum-type equation can be employed to relate Φ and [τ]:

$${Ω}^{2} Δ [ τ ] + iΩ \frac{\partial [ τ ]}{\partial β} = Φ [ τ ] , \qquad ( 1 )$$

wherein operator

$$Δ = \frac{{\partial }^{2}}{\partial {p}^{2}} + \frac{\partial }{\partial {w}^{2}} ,$$

Ω is a system-dependent diffusion-type constant, i=\sqrt{−1} and β is a “contextual biological time” variable, defined through the frequency of oscillations of the coherence of properties in a biological system, and particularly in a gene sequence. It should be appreciated that the macroscopic quantum-type of Eq. (1) facilitates extraction, or estimation, of gene sequence potential Φ. It is noted that Eq. (1) can facilitate design of sequences with specific properties (e.g., synthetic biology) as defined via gene sequence potential Φ. In addition, gene sequence potential can be utilized to efficiently store information on gene sequences, e.g., as a library of gene sequence potentials in a database, since access to Φ affords solving for a tolerance matrix [τ] for a specific discretization mesh of a gene sequence. It should also be noted that utilization of gene sequence potential for analysis and design can be directed towards (i) the noncoding part of a genome sequence or to the coding sequence of an actual gene that contains the information of a final product of a transcription of the gene, wherein the transcription can be one of natural or synthetic; and (ii) an expressed product of the transcription of the gene. Such duality of analysis with methods of the subject innovation of DNA sequence for interpretation of protein properties and function [case (ii)] can be understood in the following terms: having a sequence of coding DNA for a protein/enzyme is not different from writing the encoded amino acid sequence in a disparate 3-letter code (e.g., Met is “conventional” and “ATG” is only one equivalent of the first coding). Thus, analysis and design in (ii) can be interpreted as an effective analysis and design of a sequence (e.g., amino acid sequence) cast in different natural “language.”

To further characterize a gene sequence, or substantially any type of polymer sequence, a covariance matrix among columns of [τ] can be computed. In an aspect of the subject innovation, calculations show that covariance matrices correlate well with available protein(s) conformation as extracted from residue-residue (C_{α}-C_{α}) distance matrices with a cut off of 15 Å, for example. It should be appreciated that correlation(s) among a covariance matrix and sequence structure is lost after a “synonymous randomization” of native sequence; e.g., at each gene position, a randomly selected alternative codon replaced a wild-type (wt) codon when multiple alternative codons were available.

To yet further characterize a gene sequence, ττᵢ profiles of coding sequences where a wavelet transform is used to pinpoint protein domains and secondary structure segment boundaries of both globular and membrane proteins. Analysis reveals that low-frequency wavelets appear localized in encodings of helical domains and high-frequency wavelets in beta strand domains. The periodicity ττᵢ profiles carry substantive information that is filtered in order to extract structurally relevant information for specific sequences.

Computation of a probability distribution of values of ττᵢ profile provides information on thermodynamic parameters for a gene sequence, mutation rates, and on segment multiplets that can be present in a gene sequence.

In yet another aspect of the innovation, where a number of mutations N occurs in an original segment sᵢ^{(w)}, mutations may occur with ττᵢ-dependent rates ∂N/∂ττ_{I}, as shown in FIG. 4G. The mutations are also linearly proportional to:

$${ττ}_{i} \text{:} \frac{\partial N}{\partial {ττ}_{i}} = k {ττ}_{i} + b .$$

Therefore, the number of mutations is represented by the following equation:

N=kττᵢ²+bττᵢ+q

This equation demonstrates that among positions with ττ_{I} within a band that there are specific regions with minimal relative variability to result in conservation of sequence τ-homology. FIG. 4G illustrates a complete model of emergence of a long-range property coherence in a genome which combines the number of mutations per segment with the Planck distribution described herein with reference to FIG. 3F.

The linear proportionality of the number of mutations further infers that evolutionary change from an ancestral segment to a current segment composition preserves information about unique distribution of segment multiples and conservation of the additional level of information which is overlaid over a genomic sequence in the form of long-range coherent distributions of physiochemical properties. The wavefunctions (or frequencies) of these coherence waves as evidenced in FIG. 4G may be observable, identifying networks of long-range functional associations which are not identifiable using another method.

FIG. 4H further illustrates the extent of evolutionary optimization in genomes of different organisms and relevance of synonymous mutations. FIG. 4H illustrates distributions of differences between entromic characterizations of a complete set of coding sequences from genomes of named species and the identical entromic characterization of the same sequences modified by random synonymous replacement of all codons. These distributions depicted in the top image and the box-plots of means of these distributions illustrate that the extent of the optimization of the incorporation energy increases with the phylogeny of the species, being maximal for a human genome. A random genome represents the baseline of processing 10,000 coding sequences, generated by random uniform probability selection of codons (e.g., no optimization of the incorporation energy is present and the mean of the difference distributions is at zero). In the alternative, for a complete gene set for each of 13 species, a mean value E(τᵢ^{w}) of a distribution of τᵢ^{w} intensities in [\vec{τ}] decreases with increasing biological complexity of organism, for example, in correlation with phylogeny.

FIG. 4I additionally illustrates the relationship of entromic entropy to the rate of single point mutations in a genome. Generally, entromics theory predicts that the rate of single point mutation occurrence is linearly proportional to the entomic entropy S. This results in the prediction of the quadratic relationship between a single point mutation frequency in genome segments and a frequency of single point mutations. The left panel show this prediction for a 150 kbase segment centered at the cytochrome 2C19 gene. A) shows the distribution of the S values calculated at 750 randomly selected positions of this 150 kb segment, for example, this distribution has the original, P[S] shape. B) shows the distribution of S-values calculated at the 750 positions of the 150 kbase segment, where the single point mutations are reported. The histogram is fitted (r²=0.95, p<0.0001) by 5 quadratic functions. The right panel illustrates an application of this entromic result for selection of panels of single point mutations for microarray experiments. The distribution of the S values, computed for the 150 kbase gene segment centered at polymerase beta gene, is fitted by the sum of 6 quadratic functions. Regions of S-values at the minima of these quadratic functions are used to select candidate positions for functionally relevant probes for custom-made microarray.

Following is another example discussion of translational quantum genomic theory to assist in an understanding of the features, functions and benefits of the innovation. For this example, parts of a human (eukaryotic) genome are also used.

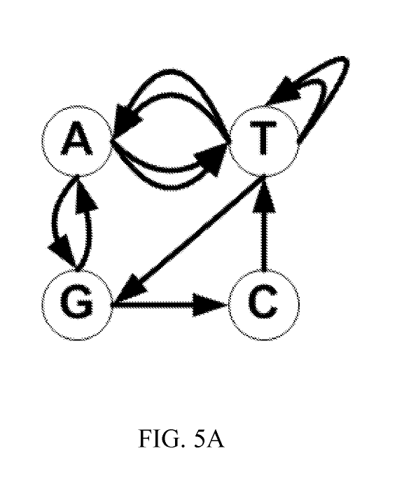

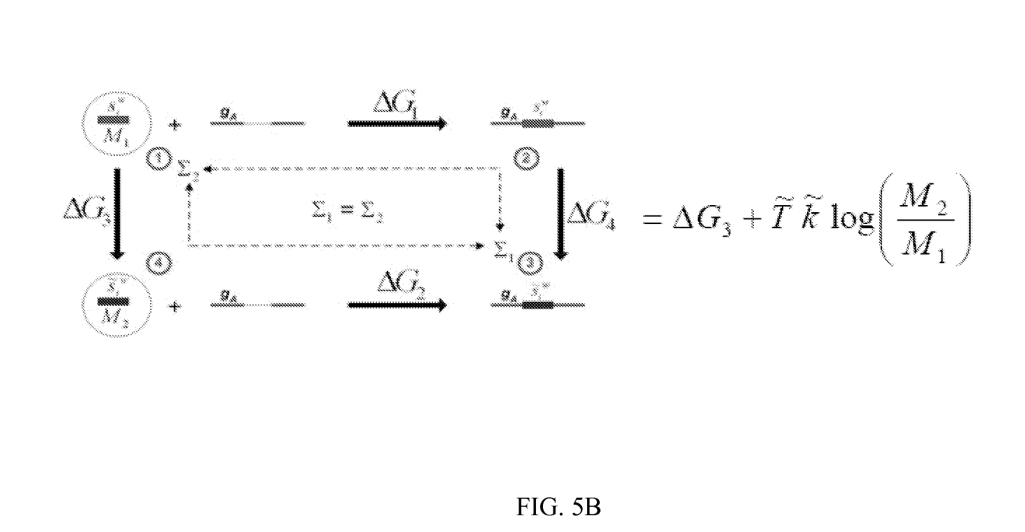

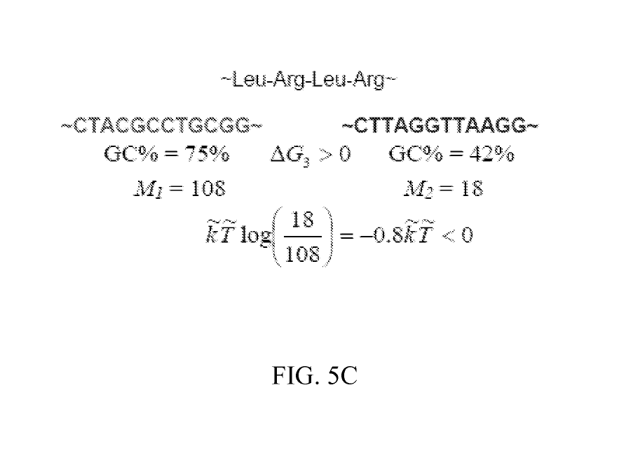

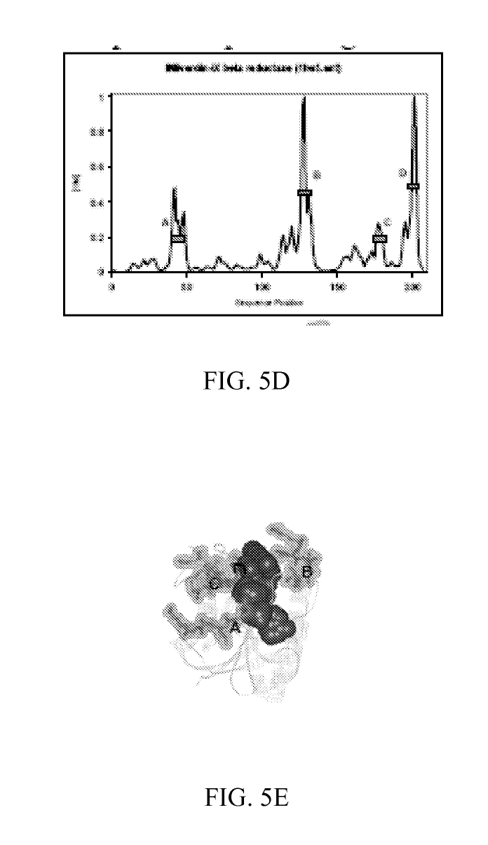

In accordance with the innovation, sequence (e.g., DNA) graphs are tools for getting revolutionary insight into the genome information. For an example DNA sequence, ˜AGCTTTATATG˜, sample Eulerian paths are shown in FIG. 5A. As illustrated, Eulerian paths in this single DNA graph generate MANY=Mᵢ non-identical DNA sequences: ˜ATGCTATTTAG˜ ˜ATTAGCTATTG˜ . . . ˜ATATTAGCTTG˜.

Because DNA is linear, it is to be understood that Mᵢ represents the number of “daughter” sequences sprouts from one “mother” sequence.

$$M = det ( {L}^{*} ) \cdot \frac{{d}^{*} ( {ν}_{\text{?}} ) ! \cdot {\prod }_{\text{?}} ( {d}^{*} ( {ν}_{\text{?}} ) - 1 ) !}{{\prod }_{\text{?}} ( {a}_{\text{?}} ) ! \cdot {\prod }_{\text{?}} m ( {ν}_{\text{?}} ) !}$$

$$\text{?} \text{indicates text missing or illegible when filed}$$

This is unique to a family of DNA sequences as they all share a thermodynamic stability ΔG_{STAB}. Mᵢ statistical thermodynamic interpretation, since every naturally occurring sequence comes from a thermodynamically homogeneous pool (population) of unique size Mᵢ, as shown in FIG. 5B.

FIG. 5C illustrates a synonymous coding for a protein segment, where kT(log(M₂/M₁)) (also an equivalent to entropy) provides a thermodynamic mechanism that may compensate for energetically unfavorable choices of genome segments. Unfavorable choices may occur due to pressure on or within a biological system. As described herein, μᵢ is a chemical potential which further describes the entropic part of the energy cost of incorporating a segment into a genome. FIG. 5D illustrates a plot of μᵢ˜1/Mi˜S as a function of position. This plot delineates maxima where the above-described entropy-based compensatory mechanism has been used to incorporate a segment into a genome sequence that would otherwise be detrimental to the stability of a resulting genome. As such, the optimization is not spontaneous and may be induced by functionality in the DNA or functionality in a product that is a translation of the encoded genetic information. FIG. 5E shows an example biliverdin reductase in which maxima as described in FIG. 5D identify the non-contiguous loops forming an active site.

As described above, the innovation provides further details of the formalism(s) related the subject innovation and illustrative application of translational quantum genomics (TQG). It is noted that the subject innovation can be utilized to analyze and design substantially any finite polymer sequence or finite solid state material that presents a linear structure. It is to be further noted that polymer sequences that display a non-linear atomic structure, but afford a graph representation with a finite number of closed paths, can be analyzed in part in accordance with aspects of the subject innovation.

Aspects of the subject innovation discussed herein can be utilized for various applications related to analysis and design of gene sequences. As examples, and not as a limitation means, the subject innovation can be utilized, at least in part, in addressing the following fundamental biological scenarios:

1. Exploitation of Φ for and protein structure and folding dynamics. Φ computed from a thermodynamic tolerance matrix [\vec{τ}] of protein coding gene sequences reflects symmetry of the protein 3D structure and e.g. for L9 ribosomal protein indicates its experimentally observed unique differences in folding of its two domains.

2. Biocompatible replacement segments generated from wild-type gene sequence and antiviral drug resistance mutations appearance in influenza. In the example, 21 base segment of wild type neuraminidase active site from H5N1 influenza virus are converted into DNA graph Γᵢ. An exhaustive set of alternative synthetic DNA segments from the pool of iso-stable sequences are generated using the Eulerian paths in Γᵢ. In a first act, these synthetic alternative DNA sequences are filtered for coding sequences. In a second act of filtering, only coding sequences are characterized by their impact on the gene context at the boundaries of the processed segment in the whole gene. It should be appreciated that this procedure also utilizes DNA graphs, from which profiles τ_{WT,LEFT}^{w} and τ_{WT,RIGHT}^{w} at the wt segment boundaries are calculated for complete set of w discretizations. Then, τ_{Synth[i],LEFT}^{w} and τ_{Synth[j],RIGHT}^{w} are calculated for every bio-compatible coding sequence that is inserted into the place of wt segment. Synthetic sequences are sorted according to Δττ, which can be calculated using overlap integrals ∫τ_{Synth[i],k}^{w}τ_{WT,k}^{w}dw for k=LEFT and k=RIGHT. A maximal overlap Δττ can indicate that iso-stable synthetic coding sequence that would replace the wt original is maximally compatible with the existing sequence context at the segment boundaries. After this dual filtering, it is found that the synthetic segment within the five top-Δττ ranked ones, for example, was substantially identical to the actually sequenced mutation in the influenza virus found to be resistant to the neuraminidase inhibitor based antivirals (strain from Vietnam).

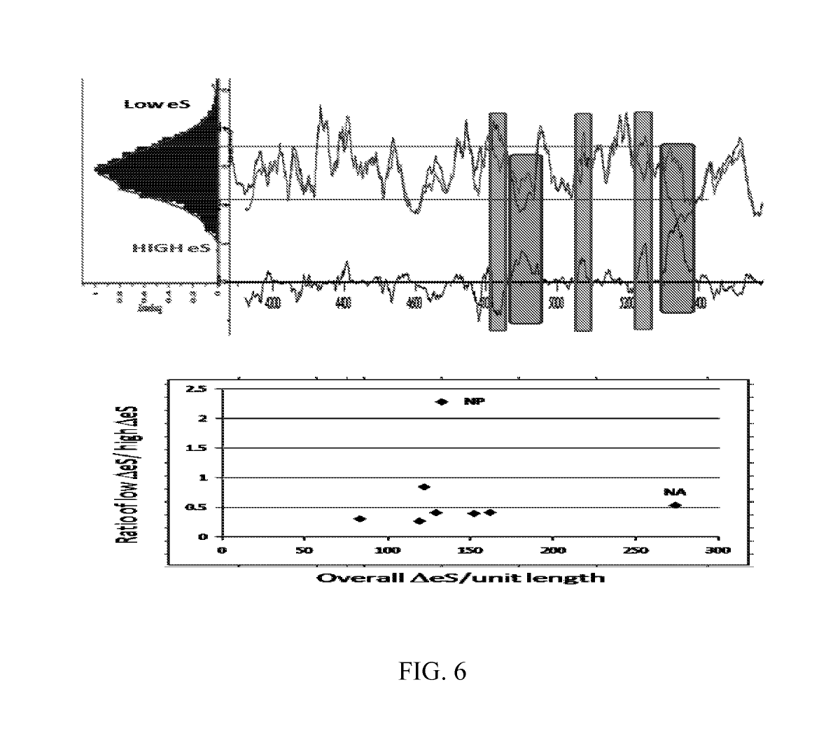

FIG. 6 illustrates a potential to mutate for a variant of influenza H1N1. The segments of H1N1 genome were aligned to the corresponding strains of phylogenetically closest variants of the respective segments of the parent viral species. Entromic entropy is calculated both for parent and the H1N1 variant. The distribution of entromic S values for the variant is shown in bottom panel and is fitted by the combination of 5 quadratic functions as required by entromic theory for highly variable genomic sequences. The profiles of entromic S for parent genomes and the H1N1 variant are shown. The bottom panel shows a summary difference of the two profiles for respective segments of virus RNA. Boxes in the plot indicate the regions where the novel assembly of the RNA segments in H1N1 variant induces the largest positive and negative change of entromic incorporation energy. The bottom panel shows that the maximal entromic diversity in the H1N1 strain is observed for an NP (nuclear protein) and an NA (neuraminidase) segments. The larger entromic S values in the boxed regions for the NP protein predict increased capacity of this protein to acquire potentially dangerous mutations, compared to parental strains of seasonal flu.

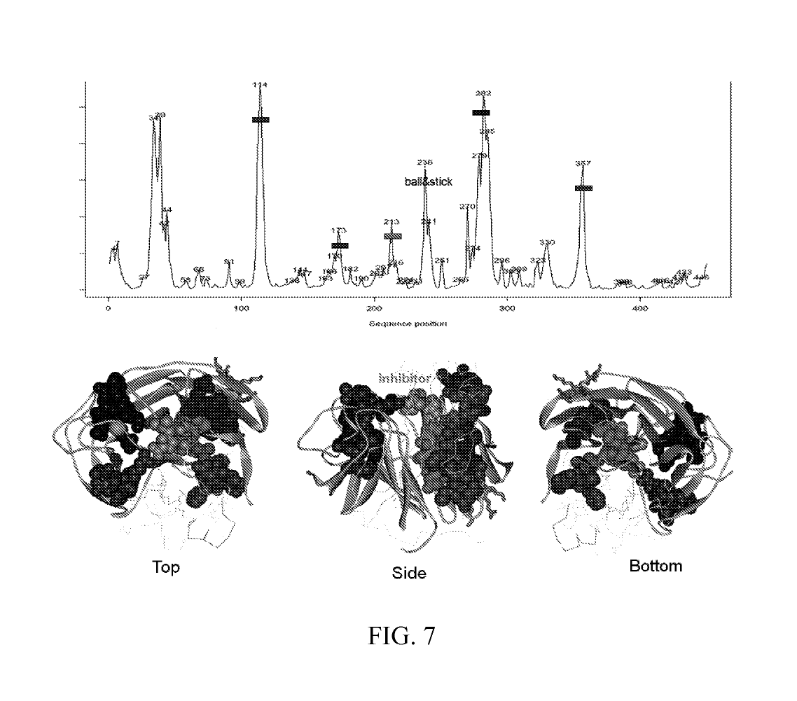

FIG. 7 illustrates that entromic characterization of biologically important regions of genomes is significant also for seasonal influenza viruses. FIG. 7 depicts the results of the characterization of the neuraminidase segment of influenza H5N1 virus. The maxima indicate regions with maximal optimization of the incorporation energy into the RNA segment. These segments are projected into the x-ray structure of neuraminidase complex with Tamiflu inhibitor. The correspondence of extremely optimized segments to active/drug binding site of the viral enzyme is indicated.

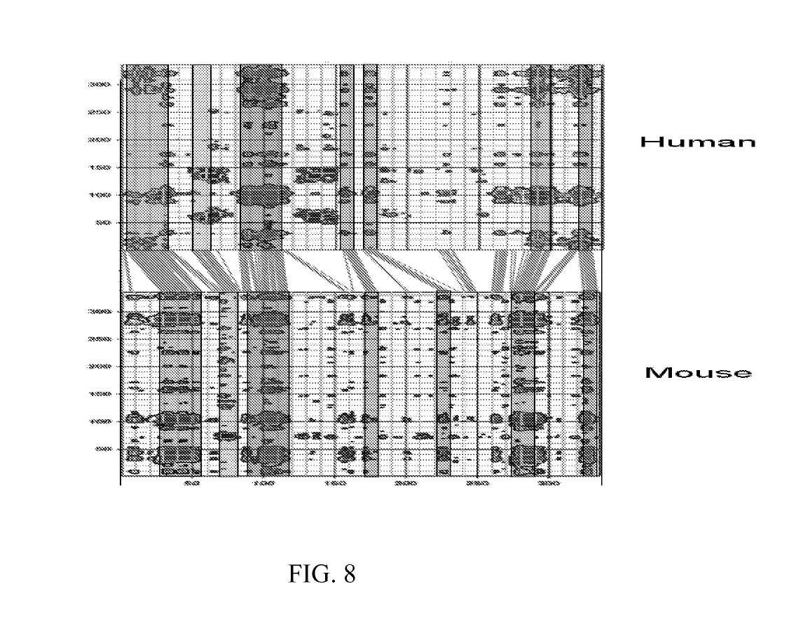

3. Thermodynamic tolerance matrix [\vec{τ}] and biological complexity. FIG. 8 illustrates a comparison of networks of entromics coherences for human and mouse polymerase beta. The top panel shows the contour visualization of the regions in human (top) and mouse (bottom) polymerase beta, the enzyme involved in DNA repair. The blue contours indicate coherences of entromic incorporation vectors for regions with extreme negative compensation of the incorporation energy by S, whereas red contours indicate coherences of entromic incorporation vectors for regions with the highest (extreme positive) compensation of the incorporation energy by S. This indicates that e.g. testing of impact of cancer-associated mutations of polymerase beta in a mouse model should not use one-to-one correspondence of the positions in the gene, as high classical sequence homology indicates, but instead a need exists to design these experiments with consideration of the functional shifts, indicated by the entromic coherence.

4. Thermodynamic tolerance matrix [\vec{τ}] and functional specialization after genome duplication. In another example, we found that 78% of genes in the S. cerevisiae have decreased τᵢ^{w} intensities compared to paralogs of ancestral K waltii.

5. Thermodynamic tolerance matrix [\vec{τ}] and protein structure. Correlation matrix rᵢⱼ=∫\vec{τ}ᵢ^{w}\vec{τ}ⱼ^{w}dw determined from a tolerance matrix [\vec{τ}] of protein CDS shows significant overlap and matching topology with C_{α} distance matrices calculated from x-ray structures of encoded proteins. This correspondence vanishes after synonymous replacement of actual codons by randomly selected alternatives.

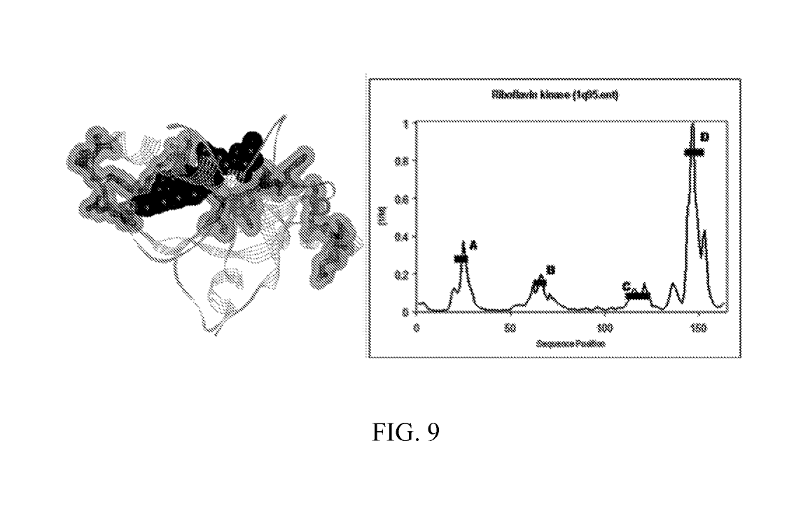

6. ττᵢ and active site of drug targets. In another example we have shown that in a large series of coding sequences for enzymes with known 3D (three-dimensional) structure of target/substrate complexes of approved drugs, non-contiguous gene segments exhibiting long-range coherence by sharing minimal ττᵢ-intensities were found encode exclusively the active/substrate binding sites. FIG. 9 illustrates an representative application of entromic result for identification of binding sites of drugs. The right panel shows, by maxima, the sections of the Riboflavin kinase coding DNA sequence that exhibit maximal optimization of their incorporation energy into a genomic DNA sequence. These segments are projected into the x-ray structure of the complex of enzyme with inhibitor, showing the correspondence of these entromically unique segments to an enzyme active site. This provides candidate regions for drug design applications of entromics.

7. ττᵢ and functional impact of mutations. Maxima in ττᵢ calculated from sequence of p53 gene identify all experimentally found positions where mutations compensate for polymorphisms in carcinogenic mutation hotspots.

8. Differences between ττᵢ calculated from reference sequence of IL4R genome and from experimentally genotyped sequences for 890 asthma patients correlate with gender differences in disease severity.

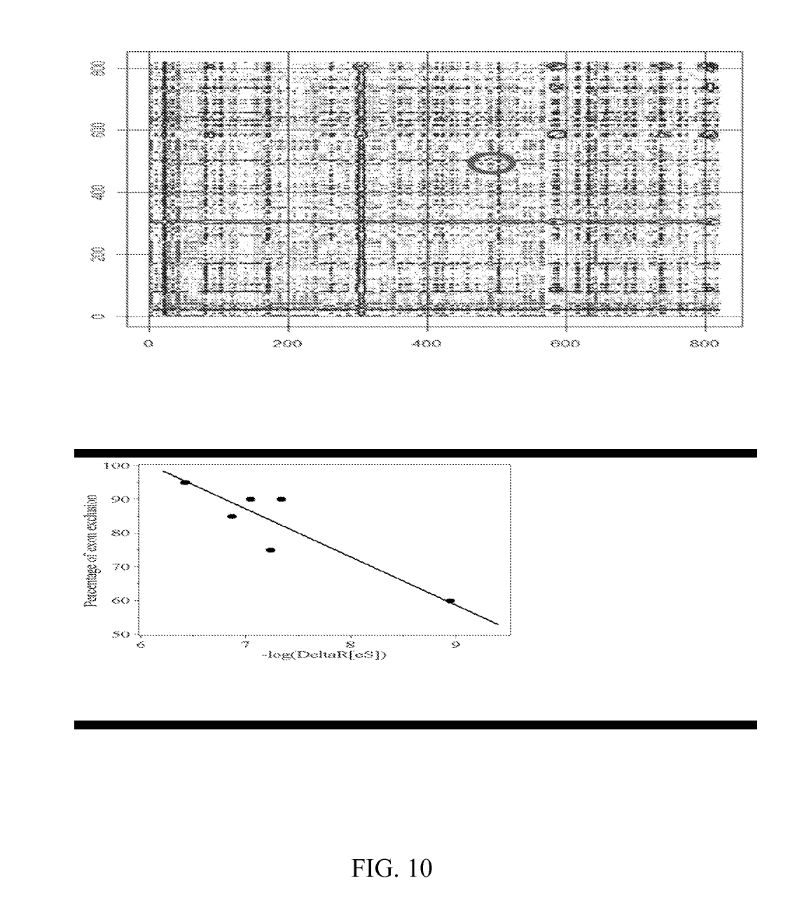

9. FIG. 10 illustrates synonymous mutations of codons within exon 12 of a cystic fibrosis conductance regulator (CFTR), which influences inclusion or exclusion of this exon in a transcribed protein. Resulting splice variants are indicated as disease risks. Authors (Pagani, F, Raponi, M. Baralle, F, PNAS, (2005), 6368-6372) provide experimental evidence by studying systematic series of engineered point mutants, that the location and the replacement base both have effect on the extent of the exon 12 inclusion and exclusion in the transcribed final protein. They do not provide any quantitative explanation for the observed results. Left panel show the computed network of entromic coherences for the segment of human CFTR gene with exon 12 (circle) and two adjacent introns (2519 bases on the left, 1494 bases on the right). It was predicted using principles of entromics, and validated by computed results as shown, that the unique influence of synonymous mutations on the exclusion or inclusion of this exon is the consequence of the exon segment being part of the significantly non-local and functionally restricted entromic coherence network. This is shown in the top panel by the network of blue contours, spanning the specific regions of the intron-exon-intron part of the gene, of which the exon (circle) is part. This entromics result indicates strong co-evolutionary optimization of the network of connected segments in this region (blue contours). Therefore, perturbation of the thermodynamic coherence in this network by synonymous mutations in the exon 12 results in the deterioration of the related properties of this segment, which influences the splicing process. Right panel show, that entromics provides not only the qualitative, but also quantitative characterization of the impact of the individual mutations. The entromics coherence matrices were computed for all sequences of studied CFTRexon 12 mutants, exhibiting the variation in inclusion relatively to wt form of the gene. We then computed the sum of the squared differences between these matrices and the matrix for wild type variant. Right panel shows, that there is significant linear correlation between these entromic characterizations of the impact of the synonymous point mutation in the exon 12 on the network of entromic contextual coherences. The global extent of this perturbation, described by the sum of the squared differences between the wild type and mutant matrices is shown to be directly proportional to the extent of the CFTR splice-form generating mechanism. The studied positions that do not show impact of their mutation on the splicing efficiency differ from these six by 10× larger capacity of the entromic entropy to compensate for the energetic effect of the point mutation in these non-functional loci. Entromic analysis of this experiment thus provides quantitative explanation not only for positive, but also for “negative” experimental results on important aspect of function of synonymous mutations.

10. ττᵢ periodicity and protein structure. After wavelet transformation of ττᵢ-profiles calculated from protein coding sequences, the wavelet power spectrum clearly identifies protein domains and secondary structure segment boundaries in both globular and membrane proteins with low frequency wavelets clearly localized in encodings of helical domains, high frequency wavelets in beta strand domains and loop regions delineated by the transitions between the wavelet domains.

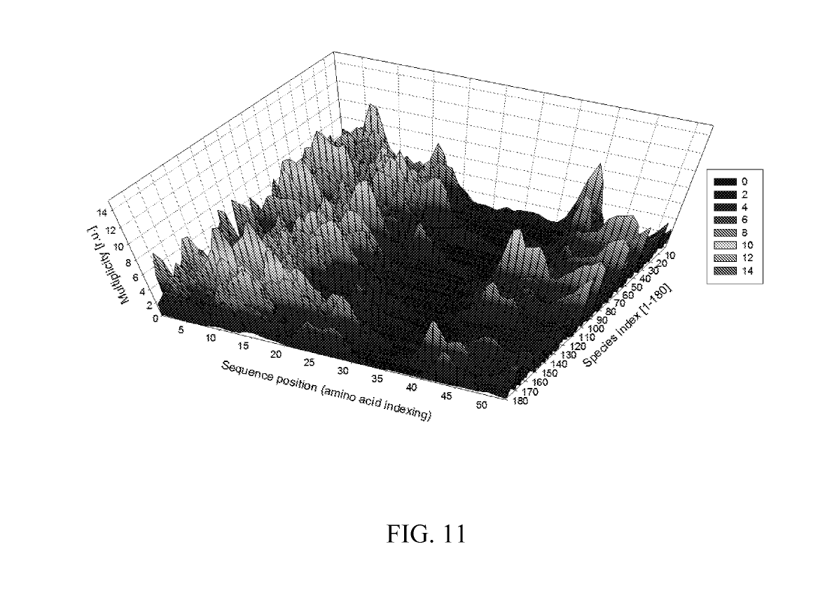

11. ττᵢ and pathogen genomic barcodes. RNA segments which code for conserved and species-specific genomic signature of 180 species of mosquito borne Alphavirus, Filovirus, Bunyavirus and Flavivirus RNA viruses all share unique maximum in their single-sequence calculated ττᵢ-profiles. FIG. 11 illustrates a set of optimal properties of the “barcode” regions for a micro-array based detection device specific for Legionella pathogen. The segments (positions 30-40 in the sequence) were selected by classical sequence similarity based application for 180 strains of Legionella, using the requirement for species specificity. Entromic theory was used to verify that these “barcode regions” are also optimally resistant against change of their sequence by pathogen mutation. FIG. 11 shows the plot of these differences for all strains. The stability of the “barcode” region (pos. 30-40) against mutation is predicted by the minimal S-difference, indicating that the associated mutations in the pathogen genome section do not influence the incorporation energy of the barcode segment.

As additional examples, the subject innovation can also be utilized for pharmaceutical applications such as design of biologic drugs and vaccines through designing parts of the genome or parts of the protein sequence with predefined properties. Generation of gene sequence potential(s) can also be utilized as an instrument for smart anti-resistance drug design, e.g., identification of active sites of enzymes and therefore drug targets, their modification by coherent replacement of important parts with segments carrying biocompatible mutations generated as in item 2. above, and screening the molecular libraries for candidate structures interacting with both original and mutated active site, as well as tool for identification of protein-protein interaction sites in conjunction with prediction of resistance inducing mutations.

Moreover, aspects of the subject innovation can assist with preparation of “technological enzymes” with predetermined response to external conditions such as higher temperature stability, modification of structure flexibility, and so forth. Furthermore, the subject innovation can be utilized advantageously for identification of unique genome signatures of pathogens for applications in detection technologies, for example in defense, and bio-terrorism countermeasures. Further yet, the subject innovation can be employed for design of the probe DNA sequences for high throughput microarray experiments. It is to be noted that because Φ captures long-range coherence(s) associated with the structure of a sequence, the effects or efficiency of a replacement gene segment in a designer drug can be naturally assessed.

It is also to be appreciated that the subject innovation can provide cross-disciplinary advantages; for instance, through generation and exploitation of gene sequence potentials and related thermodynamic tolerance matrices, and metrics derived there from (e.g., correlation matrices), the subject innovation can provide unique function-correlated input into systems biology disease models, computational models of clinical trials etc. Moreover, the subject innovation can provide unique description of host-pathogen interaction for quantitative epidemiology models. As indicated above, gene sequence potential incorporates long-range effects into such description. Furthermore, the subject innovation can provide novel disease related information that can be employed for personalized genotyping.

The subject innovation, e.g., τ-homology and gene sequence potential, can exploit at least two aspects of gene sequences and related biological systems: (i) A first aspect relates to the noncoding part of a genome sequence or to the coding sequence of an actual gene that contains information of a final product or a transcription thereof. As non-limiting examples of functionalities relevant for applications related to this first aspect, wherein a DNA sequence is not coding (e.g., introns, (untranslated regions) UTRs, repeats, . . . ), are expression regulation; design or binding of short interfering RNA (siRNA); microRNA; interactions with transcription factors; increasing or decreasing mutation rate; “killing,” or substantial mitigation of, the infectiousness of vaccine while preserving the immuno-triggering; bar-coding for detection; and so forth. (ii) A second aspect relates to the product of a transcription of a gene. Functionalities relevant for applications in this second aspect are related to properties of proteins, DNA-protein interactions, and so forth.

It should be noted that the aspects, and advantages derived thereof, described in the subject innovation can also be employed in analysis and design of AUCG and RNA, and to nucleic acid analogs with non-natural bases or modified (methylated, ubiquitinated etc.) bases.

It should also be appreciated that the subject innovation differs from existing technology and derives its novelty and unusual features from discovery of τ-homology that is more general than sequence homology, which is typically an underlying principle for substantially all methods existing for sequence analysis. It should also be appreciated that τ-homology extracted from a thermodynamic tolerance provides means for determining substantially more relevant information from the same input when compared to conventional methods. Additionally, the subject invention incorporates simultaneously deterministic tools to convert discovered important existing sequences into equivalent novel compositions of alternative sequences, e.g., through generation of non-identical sequences derived from Eulerian paths in associated graphs, which might not be even present in nature. Thus, in contrast with conventional methods, the subject innovation integrates such analytical aspect with synthetic aspects relevant to gene sequence design.

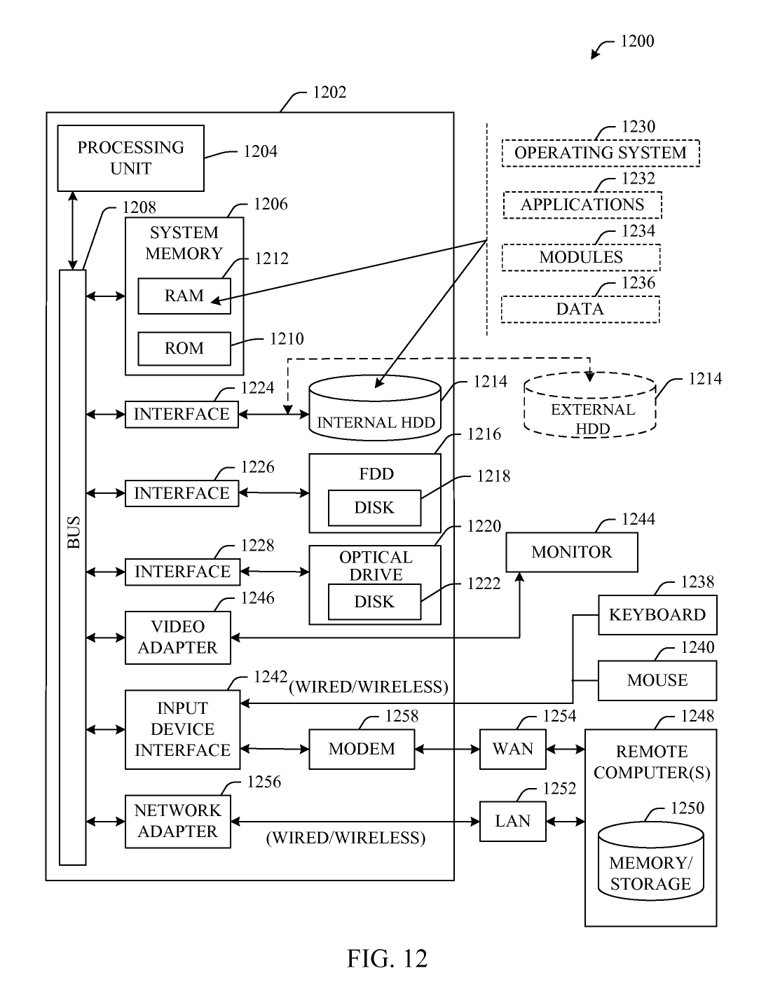

Referring now to FIG. 12, there is illustrated a block diagram of a computer operable to execute the disclosed architecture. In order to provide additional context for various aspects of the subject innovation, FIG. 12 and the following discussion are intended to provide a brief, general description of a suitable computing environment 1200 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, the exemplary environment 1200 for implementing various aspects of the innovation includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the innovation can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for gene sequence analysis and design, the method comprising:
employing a processor that executes computer executable instructions stored on a computer readable storage medium to implement the following acts:
computing a thermodynamic tolerance based at least in part on a graph representation of a gene sequence; and
estimating a gene sequence potential (Φ) based at least in part on the computed thermodynamic tolerance;
receiving a set of genome design requirements; and
assessing whether the gene sequence as characterized by Φ meets one or more of the genome design requirements.

2. The method of claim 1, wherein the gene sequence potential is derived from a scale-generalized Schrödinger equation that relates the thermodynamic tolerance and Φ.

3. The method of claim 2, wherein Φ characterizes at least in part the gene sequence at least one of a structural level or a functional level.

4. The method of claim 3, the functional level includes at least one of a conformation, a dynamic and stability behavior, or a mutation effect on at least one of a disparate gene sequence or a product of transcription of the gene sequence.

5. The method of claim 4, wherein the product of transcription of the gene sequence is one of natural or synthetic.

6. The method of claim 2, further comprising:
computing a gene sequence homology profile for a first position and a second position in the gene sequence based at least in part on the graph representation of the sequence; and
extracting a set of wavefunctions and their parameters from the gene sequence homology profile, wherein each of the set of wavefunctions and their parameters is associated with a functionality of one of a gene segment or a product of transcription of a gene segment.

7. The method of claim 6, wherein the product of transcription of a gene sequence is one of natural or synthetic.

8. The method of claim 7, further comprising:
computing a probability distribution of a thermodynamic tolerance profile value;
extracting parameters associated with the gene sequence from the probability distribution of the thermodynamic tolerance profile value; and
utilizing the extracted parameters to identify and quantitatively characterize regions of a desired functionality in at least one of a genome or a product of transcription of the genome.

9. The method of claim 8, wherein the product of transcription of the genome is one of natural or synthetic.

10. The method of claim 9, the graph representation includes a plurality of non-identical sequences generated via Eulerian paths in each segment in a set of segments that discretize the gene sequence.

11. The method of claim 10, wherein a gene sequence includes at least one of DNA, AUCG, RNA, nucleic acid analogs with non-natural bases or modified bases.

12. A system for characterization and design of gene sequences, the system comprising:
a component that generates a thermodynamic tolerance based at least in part on a graph representation of a gene sequence;
a component that computes a gene sequence potential based at least in part on the computed thermodynamic tolerance, through a generalized Schrödinger equation or through an equivalent set of mathematical equations that relates the thermodynamic tolerance and Φ; and
an evaluation component that receives a set of genome design requirements and assesses whether the gene sequence characterized by Φ meets one or more of the genome design requirements.

13. The system of claim 12, further comprising a gene sequence processor that retains a library of gene potentials and derived metrics that characterize a set of gene sequences.

14. The system of claim 13, a component that generates a graph representation for the gene sequence, the graph representation includes a finite set of paths associated each with a non-identical sequence derived from the gene sequence.

15. A system, comprising:
means for computing a thermodynamic tolerance based at least in part on a graph representation of a gene sequence; and
means for estimating a gene sequence potential (Φ) based at least in part on the computed thermodynamic tolerance, wherein Φ is derived from a generalized Schrödinger equation or through an equivalent set of mathematical equations that relates the thermodynamic tolerance and Φ.

16. The system of claim 15, further comprising means for determining whether the gene sequence characterized by Φ meets a set of predefined genome design requirements.

17. The system of claim 15, further comprising means for computing a gene sequence homology profile for at least a first position and at least a second position in the gene sequence based at least in part upon the graph representation of the gene sequence.

18. The system of claim 15, wherein Φ characterizes the gene sequence in at least one of a structural level or a functional level.

19. The system of claim 15, further comprising:
means for computing a probability distribution of a thermodynamic tolerance profile;
means for extracting a plurality of parameters associated with the gene sequence from the probability distribution of the thermodynamic tolerance profile; and
means for identifying or quantitatively characterizing, based upon a subset of the extracted plurality of parameters, a plurality of regions of a desired functionality in at least one of a genome or a product of a transcription of the genome.

20. The system of claim 15, wherein the product of the transcription of the genome is one of natural or synthetic.
